(19) United States
(12) Patent Application Publication
(10) Pub. No.: US 2015/0106226 A1
(43) Pub. Date: Apr. 16, 2015

(54) GAMING MARKETPLACE APPARATUSES, METHODS AND SYSTEMS

(71) Applicant: CBS Interactive Inc., San Francisco, CA (US)

(72) Inventor: Zachary James Edson, Sacramento, CA (US)

(21) Appl. No.: 14/578,139

(22) Filed: Dec. 19, 2014

Related U.S. Application Data
(63) Continuation of application No. 13/211,411, filed on Aug. 17, 2011.

(51) Int. Cl. G06Q 30/06

(52) U.S. Cl. CPC G06Q 30/0631
USPC 705/26.7

(57) ABSTRACT

The GAMING MARKETPLACE APPARATUSES, METHODS AND SYSTEMS (“UBGER”) transform user site navigation inputs via UBGER components into systematically-defined user behavior-based game exchange recommendations and offers. In one embodiment, the UBGER obtains activity logs including data on actions taken by a user within a website. The UBGER extracts user behavioral attributes based on analyzing the obtained activity logs, and queries a database for identifications of electronic games associated with the extracted user behavioral attributes. The UBGER queries a database for electronic games owned by the user, and identifies inactive electronic games owned by the user, based on the activity logs. The UBGER generates an offer including a recommendation for trade-in of one of the identified inactive electronic games in exchange for the purchase of one of the electronic games associated with the extracted user behavioral attributes, and provides the generated offer to a client device of the user.

### RELATED APPLICATION

This application is a Continuation of U.S. patent application Ser. No. 13/211,411, entitled “GAMING MARKETPLACE APPARATUSES, METHODS AND SYSTEMS”, filed Aug. 17, 2011; the aforementioned application is hereby incorporated by reference in its entirety for all purposes.

### FIELD

The present inventions are directed generally to apparatuses, methods, and systems for game-related marketplace transactions, and more particularly, to GAMING MARKETPLACE APPARATUSES, METHODS AND SYSTEMS.

### BACKGROUND

Users may play a wide variety of games provided in a variety of manners or formats, including electronic gaming consoles, compact discs (CD), downloadable software games, and the like. Such games may share similar characteristics, such as genre, style of play, and the like. Users may desire to acquire new games to play, or dispose of games they no longer play.

### BRIEF DESCRIPTION OF THE DRAWINGS

The accompanying drawings illustrate various non-limiting, example, inventive aspects in accordance with the present disclosure:

FIGS. 1A-B show block diagrams illustrating example aspects of a gaming marketplace in some embodiments of the UBGER;

FIG. 2 shows a user interface diagram illustrating example aspects of a gaming marketplace recommendation in some embodiments of the UBGER;

FIG. 3 shows a data flow diagram illustrating an example procedure to track gamer activity in some embodiments of the UBGER;

FIGS. 4A-B show data flow diagrams illustrating an example procedure to generate marketplace exchange recommendations in some embodiments of the UBGER;

FIG. 5 shows a block diagram illustrating example factors that may be utilized to generate marketplace exchange recommendations in some embodiments of the UBGER;

FIGS. 6A-B show logic flow diagrams illustrating example aspects of analyzing gamer behavior in some embodiments of the UBGER, e.g., a Gamer Behavior Analysis (“GBA”) component;

FIG. 7 shows a logic flow diagram illustrating example aspects of aggregating gaming statistics in some embodiments of the UBGER, e.g., an Aggregate Gaming Statistics Generation (“AGSG”) component;

FIGS. 8A-B show logic flow diagrams illustrating example aspects of generating buy recommendations in some embodiments of the UBGER, e.g., a Buy Recommendation Generation (“BRG”) component;

FIGS. 9A-B show logic flow diagrams illustrating example aspects of generating sell recommendations in some embodiments of the UBGER, e.g. a Sell Recommendation Generation (“SRG”) component; and

FIG. 10 shows a block diagram illustrating embodiments of a UBGER controller.

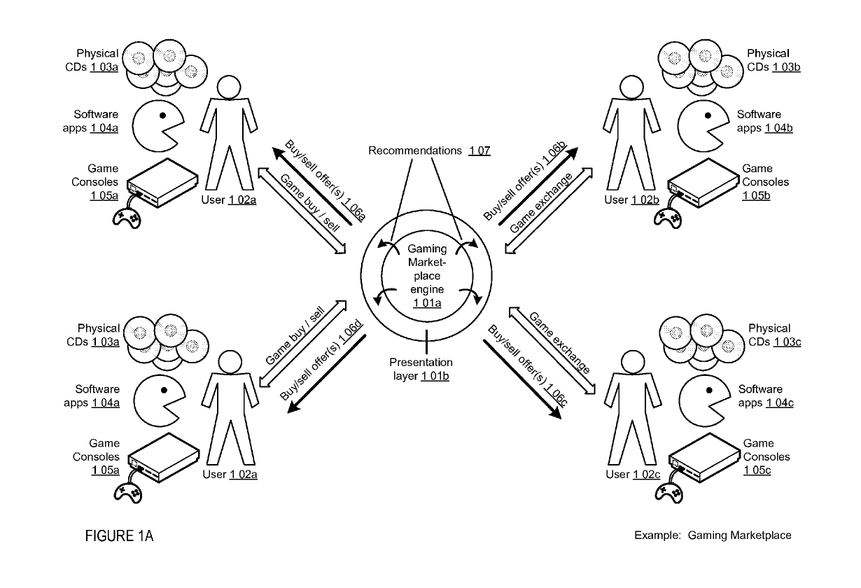

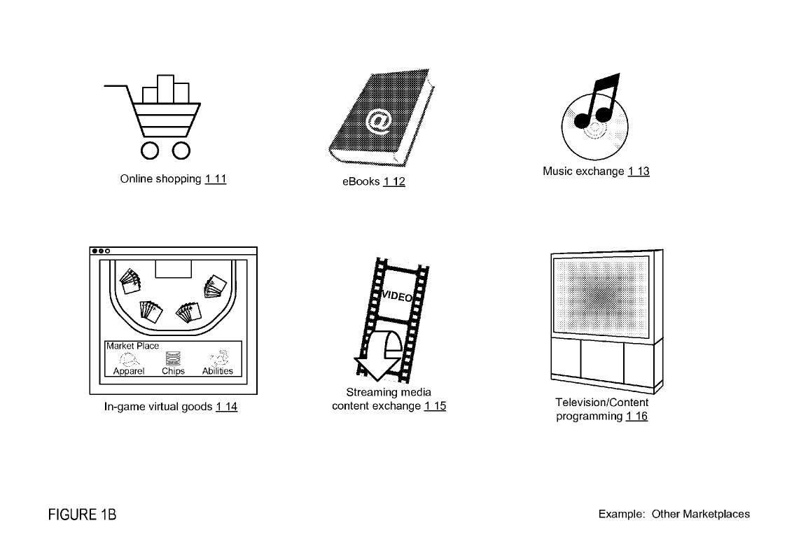

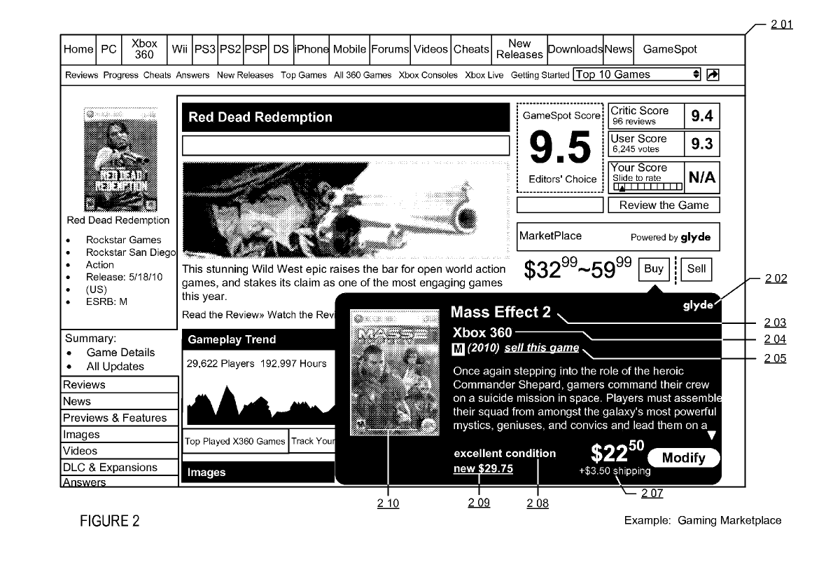

The leading number of each reference number within the drawings indicates the figure in which that reference number is introduced and detailed. As such, a detailed discussion of reference number 101 would be found and introduced in FIG. 1. Reference number 201 is introduced in FIG. 2, etc.

### DETAILED DESCRIPTION

### User Behavior-Based Game Exchange Recommendation (UBGER)

The GAMING MARKETPLACE APPARATUSES, METHODS AND SYSTEMS disclosed herein transform user site navigation inputs into systematically-defined user behavior-based game exchange recommendations and offers (“UBGER”).

FIGS. 1A-B show block diagrams illustrating example aspects of a gaming marketplace in some embodiments of the UBGER. In some implementations, the UBGER, e.g., gaming marketplace 101, may provide users with a marketplace for buying and selling games. For example, the UBGER may analyze user online and gaming behaviors to develop recommendations on games for the user to buy or sell. For example, users, e.g., 102a-d, may have games including, but not limited to: physical compact discs (CDs), e.g., 103a-d, software applications/module/download, e.g., 104a-d, game consoles, e.g., 105a-d, and the like. In some implementations, the UBGER may facilitate users buying, selling, or trading such games between each other via the marketplace. For example, the UBGER may facilitate a user buying or selling a game for money (or equivalents), virtual currency, rewards points, airline miles, and like sources of purchasing power. As another example, the UBGER may facilitate a user buying a game in exchange for selling another game. In some implementations, the UBGER may provide recommendations, e.g., 107, for which game to buy and sell to the users. For example, the UBGER's gaming marketplace engine may develop recommendations based on the market value of games available in the marketplace, the historical trends of such market values of games in the marketplace, and the users' behavioral characteristics, such as: what genre of games the user plays, what time does the user play, which devices the user utilizes for game play, the network of users with whom the user plays or trades games, and the like. In some implementations, the recommendations 107 are provided by the gaming marketplace engine 101a to a presentation layer 101b. In such implementations, some of the recommendations generated by the marketplace engine may be converted into offers by the presentation layer and provided to the users. For example, the presentation layer may format the offers for delivery to the user, and may determine delivery characteristics such as the mode of delivery, frequency of delivery, schedule of delivery and/or the like. For example, the presentation layer may determine whether to send offers formatted using the recommendations from the gaming marketplace engine via email, Facebook® wall posting, Twitter™ tweets, as an in-app object or graphical element, as an element of a personalized webpage, blog, etc. The presentation layer may also determine when to deliver the offer to the user, which device to deliver the offer to, at what frequency and intervals to deliver the offers, whether to deliver the offer to a member of a social graph of the user instead (e.g., to provide an inducement offer to the social graph member to induce the user to accept the actual underlying offer), to determine the relevancy of a context (e.g., a web page, blog post, etc.) to the offer and place the offer in its relevant context, and the like.

It is to be understood that such a marketplace including buy or sell recommendations based on user behavior may be created for other contexts besides gaming where users interact with content and where the user's activities or other inputs or attributes can be tracked. For example, the UBGER may create a virtual shopping marketplace in with recommendations by tracking a user's web browsing or gaming activity, and generating recommendations for the virtual goods, e.g., in-game goods 114, based on the web browsing or gaming activity. As another example, the UBGER may create an e-book trading exchange 112. The UBGER may be able to track (e.g., via e-readers equipped with a network connection) which e-books a user reads, the amount of time the user reads the books, when he/she reads the book, what types of books are read more often than others, etc. The UBGER may be able to generate buy, sell or lending recommendations for the user based on the user's e-book reading activity. Similarly, the gaming marketplace concept may be utilized with entertainment platforms, such as music exchange 113, streaming media content exchange, television/content programs and the like.

FIG. 2 shows a user interface diagram illustrating example aspects of a gaming marketplace recommendation in some embodiments of the UBGER. In some implementations, a user may utilize a client device providing a user interface for the user. For example, the client may be executing a browser application providing a display of a webpage of a web site for the user, e.g., 201. The web interface may include a time and data dependent multi-component offer for the user, e.g., 202. For example, the offer may include a recommendation to buy or sell a product, e.g., 203. The product may be a game that is selected based on the user's device, e.g., 204. In some scenarios, the user may have a copy of the game. The offer may recommend that the user sell the user's copy of the game, e.g., 205. In some scenarios, the user may be allowed to provide customized settings for the attributes of the product, e.g., 206. For example, the user may be able to modify the quality of condition, e.g., 208, of the product, or the earliest that the user may be able to provide the product for shipping, see e.g., 207. Upon modifying the attributes, the offer may be automatically updated so that the price of the product is modified in real-time to reflect the user-set attributes of the product and associated services. In some implementations, the UBGER may determine a market value for the buy and sell recommendation, e.g., 207, 209. For example, the UBGER may determine a market value for the advertised game based on the value of similar transactions, the condition of the advertised game, e.g., 208, the market value of the trade-in game of the user, and the like.

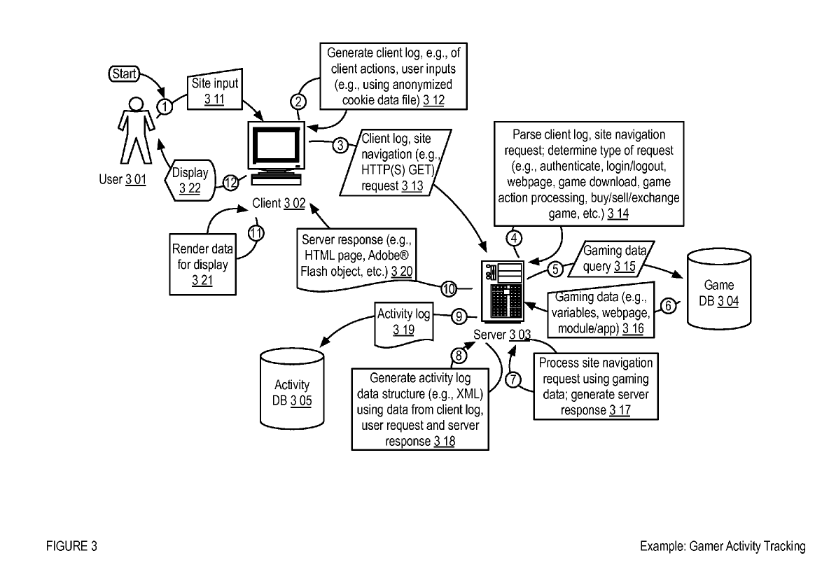

FIG. 3 shows a data flow diagram illustrating an example procedure to track gamer activity in some embodiments of the UBGER. In some implementations, a user 301 may wish to interact with an online resource, such as a website, game, social network, etc., hosted on server 303. The user may utilize a client 302 communicating with the server 303. For example, the user may provide user input, e.g., site input 311, into the client device. In various implementations, the user input may include, but not be limited to: keyboard entry, mouse clicks, depressing buttons on a joystick/game console, voice commands, single/multi-touch gestures on a touch-sensitive interface, touching user interface elements on a touch-sensitive display, and the like.

In some implementations, the client 302 may generate a log of the actions taken by the user. For example, the client may have stored in memory a (Secure) Hypertext Transfer Protocol (HTTP(S)) cookie file, which may log the actions of the user. The text of an example cookie file is provided below:

Content-type: text/html
Set-Cookie: userlog=john.public; path=/; expires Tue, 15-May-2011 14:22:12 GMT

| | |
|---|---|
| .game.com TRUE / FALSE 994668456 | URL1 www.market.com/redemption.html |
| .game.com TRUE / FALSE 994668459 | URL2 www.market.com/gamespot.html |

In some implementations, the client may generate a site navigation message for the server, e.g., 313. For example, the site navigation message may include instructions for the server to log a user into or out of a web service, provide a web page or other file, execute an instruction as part of a single or multi-user game, process a buy, sell, and trade transaction for a game, and the like. As another example, the site navigation message may include the client log stored on the client. For example, a browser application executing on the client may provide, as a site navigation message, a HTTP(S) GET message for a HyperText Markup Language “HTML”) page, wherein the HTML page include JavaScript™. commands to embed an Adobe® Flash object including an application for the user in the HTML page, similar to the example below:

GET /onlinegame.html HTTP/1.1
Host: www.gamespot.com
User-Agent: Mozilla/4.0

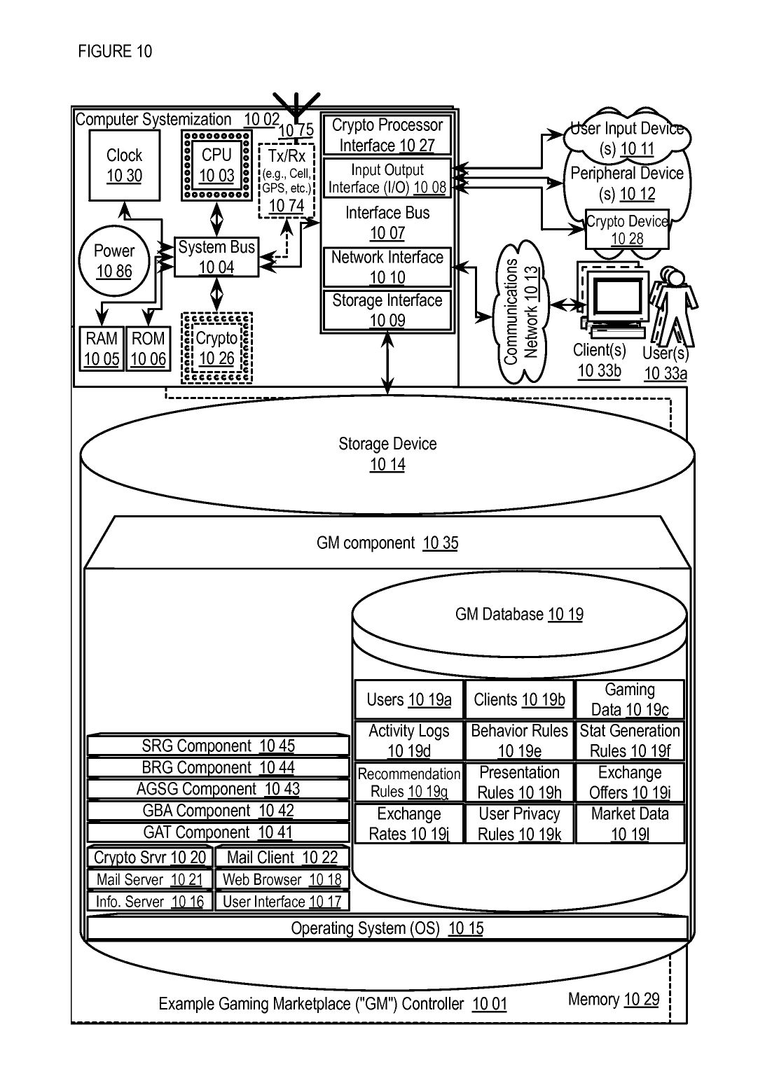

In some implementations, the server may obtain the site navigation request from the client, and parse the site navigation request to extract the data fields and values stored therein, e.g., 314. For example, the client may use a parsing procedure similar to the parser described below in the discussion with reference to FIG. 10. Based on parsing the request, the server may determine the type of instructions included in the message (log a user into or out of a web service, provide a web page or other file, execute an instruction as part of a single or multi-user game, process a buy, sell, and trade transaction for a game, etc.). The server may generate a query for data to process the instructions from the site navigation request (“gaming data”), and issue the query to a database, e.g., game database 304. For example, the database may be a relational database responsive to Structured Query Language (“SQL”) commands. The server may execute a hypertext preprocessor (“PHP”) script including SQL commands to query the database for gaming data. An example PHP/SQL command listing, illustrating substantive aspects of querying the database, is provided below:

<?PHP
header(′Content-Type: text/plain′);
mysql_connect(″255.33.129.109″,$DBserver,$password); // access database
server
mysql_select_db(″GAME.SQL″); // select database table to search
//create query for game data
$query = ″SELECT obj_id obj_name obj_data FROM MediaTable WHERE embedpage
LIKE ′%′ $page″;
$result = mysql_query($query); // perform the search query
mysql_close(″GAME.SQL″); // close database access
?>

In response to obtaining the server's gaming data query, e.g., 315, the game database may provide, e.g., 316, the gaming data to the server. In some implementations, the server may utilize the gaming data to process the site navigation request and generate a server response to the site navigation request, e.g., 317. The server may also generate an activity log for the user, e.g., 318, using data on the user's actions on the client from the client log and the contents of the site navigation request. For example, the server may generate an activity log data file encoded according to the eXtensible Markup Language (“XML”), similar to the example below:

```
<?XML version = ″1.0″ encoding = ″UTF-8″?>
<activity_log>
<user_ID>john.q.public@gmail.com</user_ID>
  <action>
    <timestamp>2011-02-22 15:22:43</timestamp>
    <type>URL</type>
    <value>www.game.com/gamespot.html</value>
  </action>
  <action>
    <timestamp>2011-02-22 15:22:43</timestamp>
    <type>app purchase</type>
    <value>[www.game.com/redemption.fla shirt ID:A2378]</value>
  </action>
</activity_log>
```

In some implementations, the server may store, e.g., 319, the activity log for the user in a database, e.g., activity database 305. For example, the server may execute PHP/SQL commands similar to the example below:

<?PHP
header(′Content-Type: text/plain′);
mysql_connect(″254.92.185.103″,$DBserver,$password); // access database server
mysql_select(″ACTIVITY.SQL″); // select database to append
mysql_query(″INSERT INTO UserTable (user_id, timestamp, action_type,
action_name, action_value, URL_resource)
VALUES ($userid, time( ), $acttype, $actname, $actvalue, $resource)″); // add data
to table in database
mysql_close(″ACTIVITY.SQL″); // close connection to database
?>

In some implementations, the server may provide the server response to the client, e.g., 320. For example, the server response may include a web page, an application module or object (e.g., a JavaScript™. code module, an Adobe® Flash object, a HTML video, an image, a file provide by a file transfer protocol, etc.). For example, with reference to the example browser HTTP(S) GET request above, the server may provide an HTML page including a reference to an Adobe® Flash object stored on the sever, similar to the example below:

<html>
<div id=″GameSpot″>
If you′re seeing this, you don′t have Flash Player installed. </div>
<script type=″text/javascript″>
var app = new SWFObject(″http://games.appserver.com/onlinegame.swf″,
″Media″, ″640″, ″480″, ″8″, ″#000000″);
app.addParam(″quality″, ″high″);
app.write(″GameSpot″);
</script>
</html>

Upon obtaining the server response, the client device may render, e.g., 321, the contents of the server response and display, e.g., 322, them for the user. For example, with reference to the examples above, a web browser executing on the client may render the HTML web page and may communicate with the server to download the Adobe® Flash object. An Adobe® Flash browser plug-in installed on the client and operating in conjunction with the browser may execute the downloaded Flash object for presentation to the user.

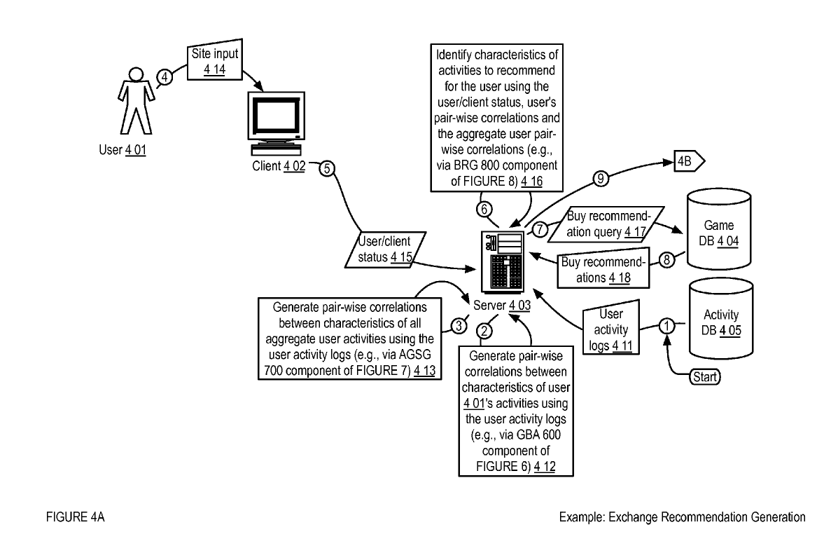

FIGS. 4A-B show data flow diagrams illustrating an example procedure to generate marketplace exchange recommendations in some embodiments of the UBGER. In some implementations, a server 403, may attempt to generate exchange recommendation for a user (e.g., recommendations to buy, sell, or trade games). The server may obtain activity logs for a user for whom the server may generate recommendations, as well as activity logs for other users of the UBGER to generate statistical correlation information, based on which the recommendations for the user may be made. For example, the server may query an activity database, e.g., 405, using PHP/SQL commands similar to the examples above, to obtain activity logs for the user and other users of the UBGER, e.g., 411.

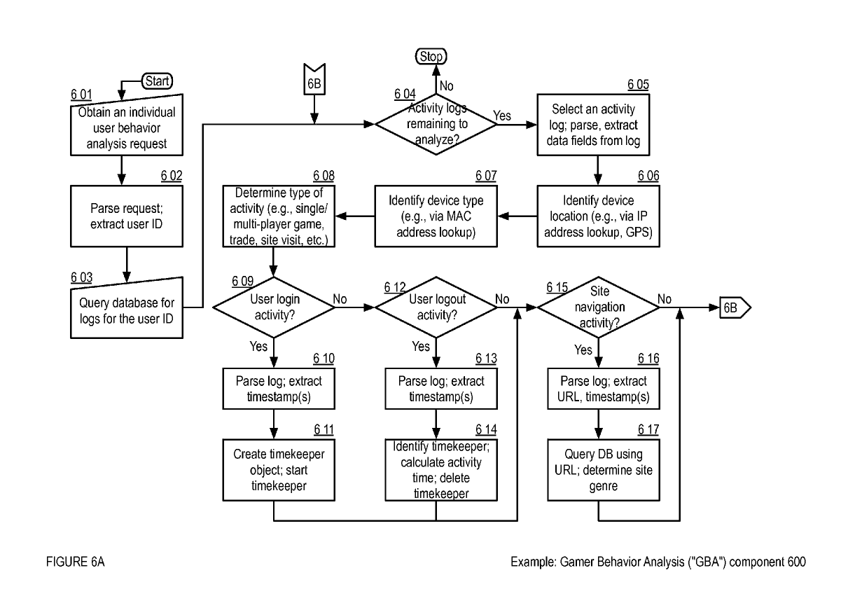

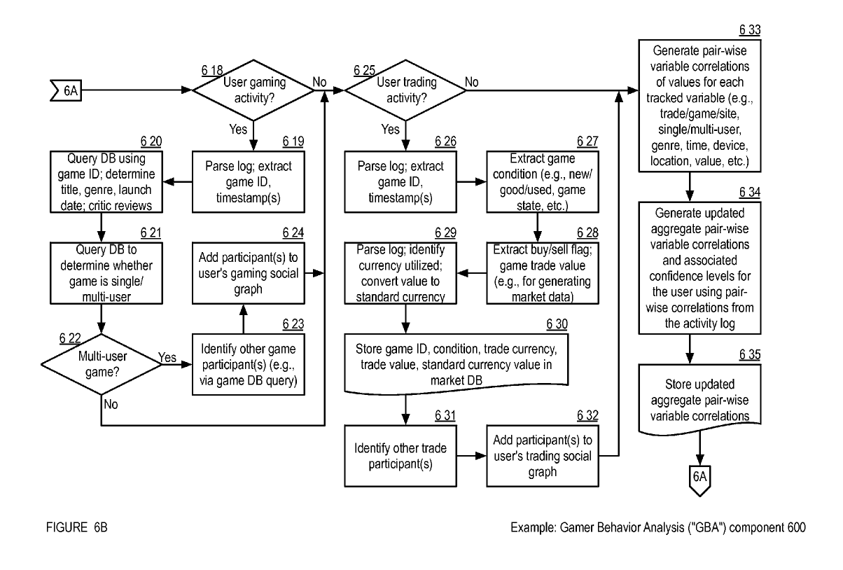

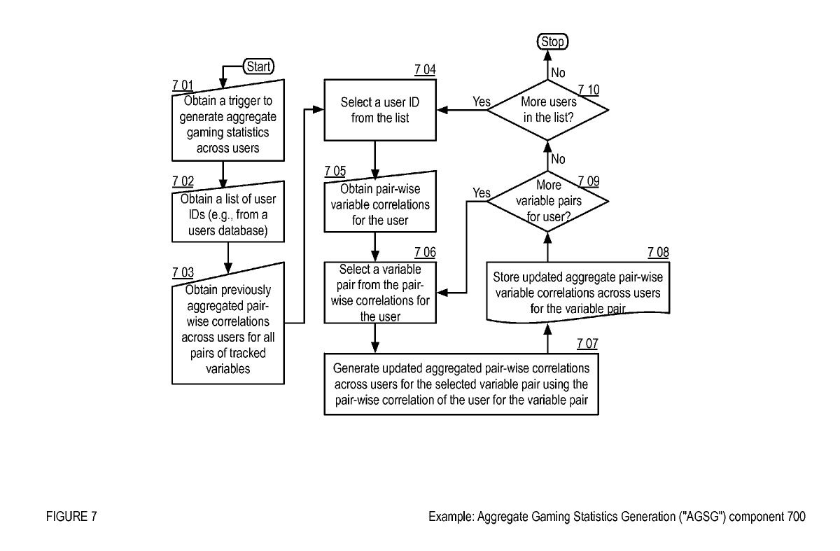

In some implementations, the server may generate pair-wise correlations between various usage characteristics of the user, e.g., 412. For example, the server may generate statistical information on what type of games the user plays, what types of device the user uses to play the games, when the user usually plays the games, with whom the user plays the games, which games does the user buy, sell or trade, what condition (e.g., new, good, used, etc.) the games are in that the user buys, sells or trades, and the like, and how these variables correlate with each other (e.g., if the value of variable 1 is X, what is the most probable value of variable 2?; if the value of variable 1 is X, what is the probability that the value of variable 2 is Y?; etc.). For example, the server may utilize a component such as the GBA 600 component, described in greater detail below in the discussion with reference to FIG. 6, to generate the pair-wise correlations for the user. In some implementations, the server may generate pair-wise correlations between usage characteristics of all users in the aggregate, using the activity logs of all the users. For example, the server may utilize a component such as the AGSG component, described in greater detail below in the discussion with reference to FIG. 7, to generate the pair-wise correlations across all users in the aggregate.

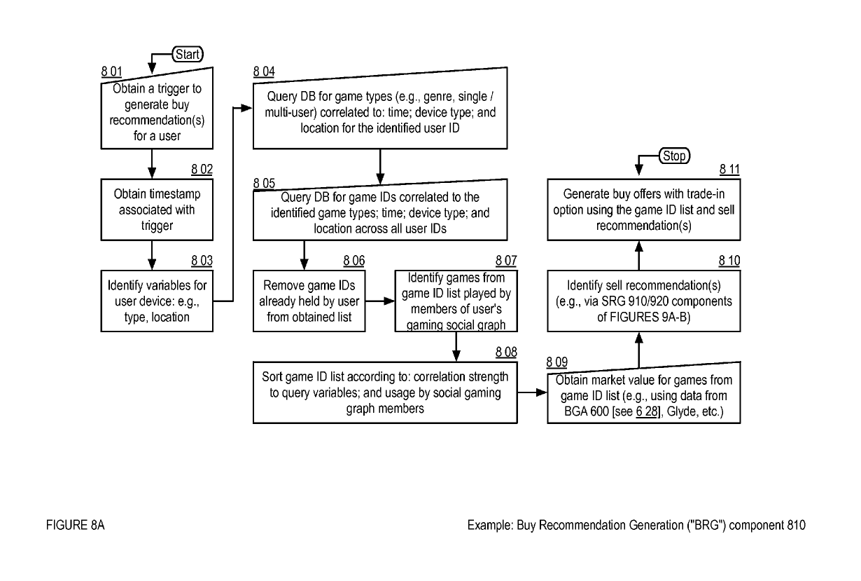

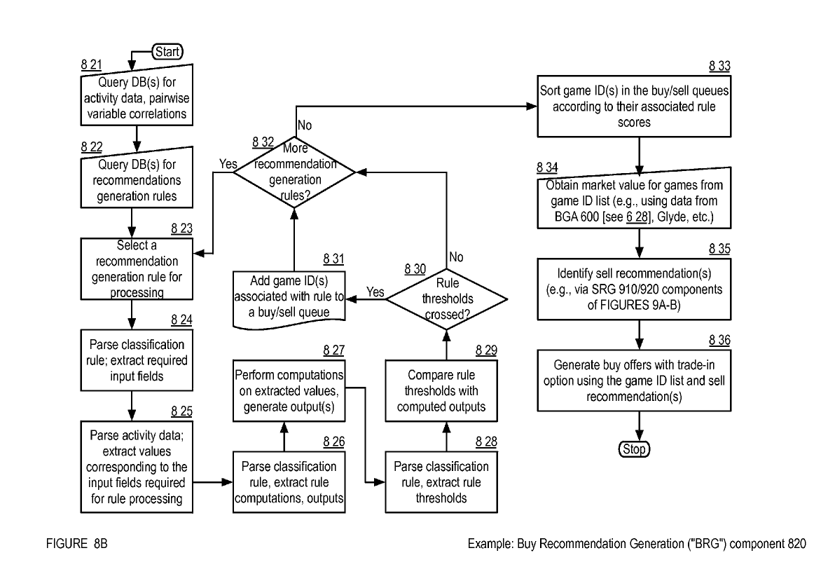

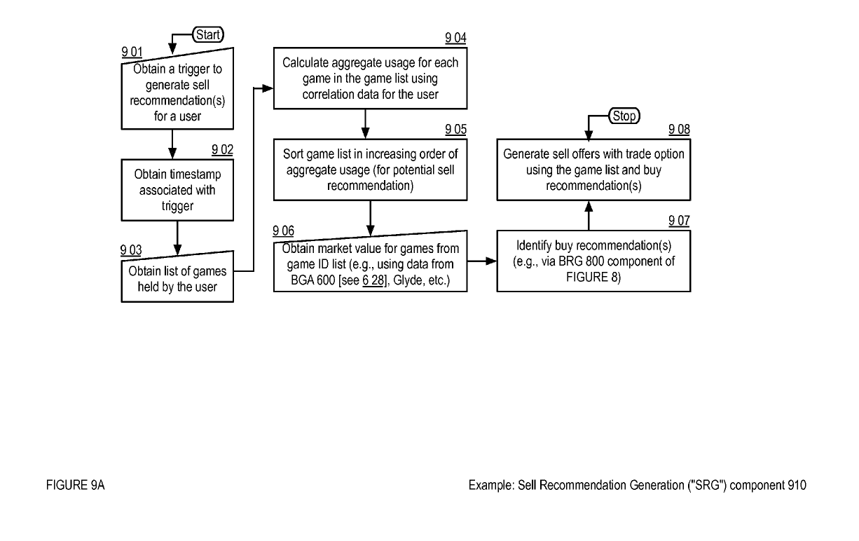

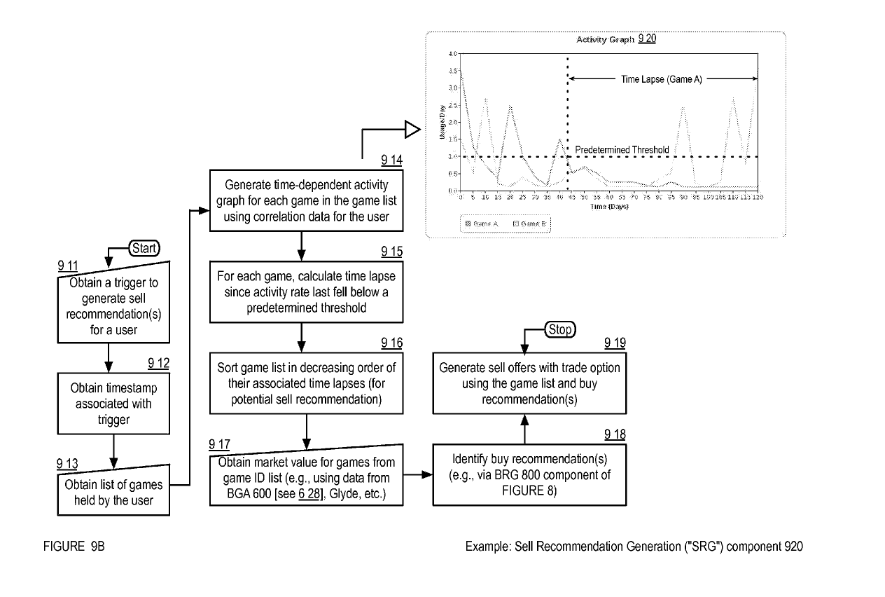

In some implementations, the server may utilize a current status of the user and client to determine recommendations for the user. For example, the user 401 may utilize a client 402 communicating with the server 403. For example, the user may provide user input, e.g., site input 414, into the client. In response, the client may provide the server with the user input as well as a user/client current status (e.g., a client log; a memory state of the client; a data structure representative of the in-game status of a gaming app, etc.). For example, the client may provide a HTTP(S) POST message including XML status and user input data similar to the examples above. Using the user input, the user's and clients current status, and the correlation for the user and across all the users, the server may determine characteristics of the activities that may be suitable recommendations for the user. For example, the server may utilize components such as the BRG 800 and SRG 900 components, described in greater detail below in the discussion with reference to FIGS. 8 and 9, to identify characteristics of games that may be recommended for the user to buy, and to generate buy, sell or trade recommendations for the user. In some implementations, the server may utilize characteristics of the user and the aggregate users to query a database, e.g., game database 404, for games that may be recommended for the user, e.g., buy recommendation query 417. In response, the game database may provide a list of games matching the characteristics of the user, and of users having similar characteristics to those of the user. In some implementations, the server may also query a database, e.g., activity database 405, for a list of games that the user has access to but that the user does not utilize much, e.g., inactive games query 420. In response, the activity database may provide a list of inactive user games of the user, e.g., 421. In some implementations, the server may also query a database, e.g., game database 404, for market value data on the games included in the recommendation list and the inactive list, e.g., 422. In response, the game database may provide market data on the games, e.g., 423.

In some implementations, using the list of recommended games for the user, an inactive games list for the user, and market value data for the game on the recommended and inactive lists, the server may generate buy/sell recommendation presentations (“offers”) for the user, e.g., 424. For example, these may be time and data dependent multi-component offers for the user that may require the user to buy and sell games within pre-specified timelines and at market-based prices, where the games utilized in the offers may be based on the user's behavioral characteristics during site navigation and those of other users having shared behavioral characteristics with the user during site navigation. In some implementations, the server may generate a presentation tailored to the user's behavioral characteristics during site navigation. For example, the offer may be formatted according to the display characteristics of the client device used by the user during site navigation at the time that the server makes the offer to the user. As another example, the offer may be formatted according to a game currently being played by the user. As another example, the offer may be presented as part of a game currently being played by the user. For example, the in-game environment of the user may be modified in real-time to include the offer, and the offer may be formatted so as to offer a seamless experience for the user within the gaming environment. As another example, the server may format the offers for delivery to the user, and may determine delivery characteristics such as the mode of delivery, frequency of delivery, schedule of delivery and/or the like. As another example, the server may format the offer for presentation via email, Facebook® wall posting, Twitter™ tweets, as an in-app object or graphical element, as an element of a personalized webpage, blog, etc. The server may also determine when to deliver the offer to the user, which device to deliver the offer to, at what frequency and intervals to deliver the offers, whether to deliver the offer to a member of a social graph of the user instead (e.g., to provide an inducement offer to the social graph member to induce the user to accept the actual underlying offer), to determine the relevancy of a context (e.g., a web page, blog post, etc.) to the offer and place the offer in its relevant context, and the like. The server may provide, e.g., 425, such buy/sell offers to the client for display to the user according to the presentation guidelines that it determines to be appropriate. The client may render, e.g., 426, the offer and present, e.g., 427, the offer to the user.

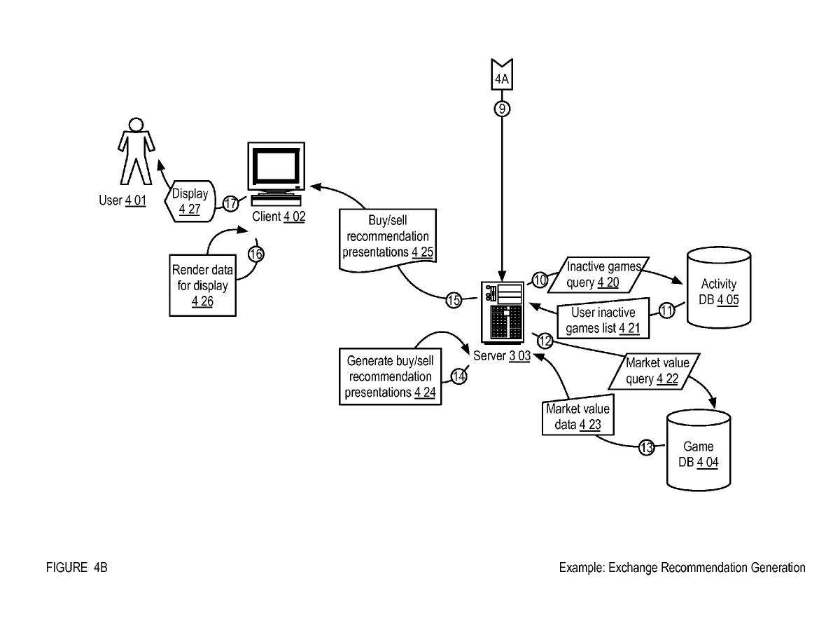

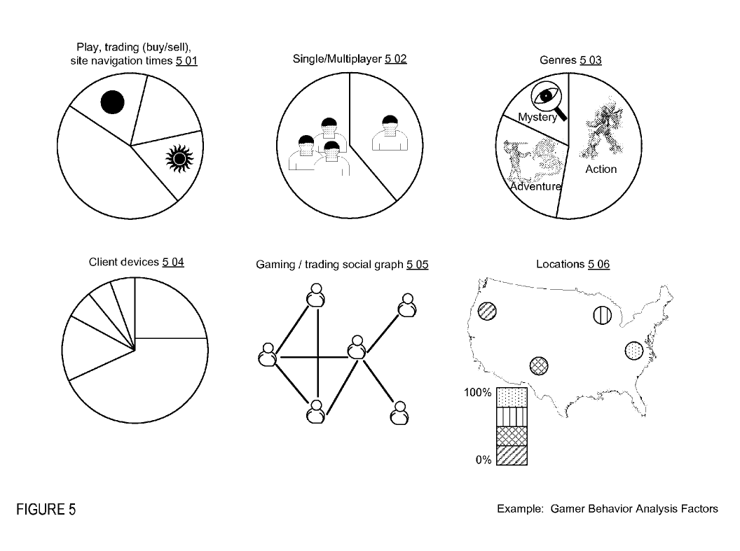

FIG. 5 shows a block diagram illustrating example factors that may be utilized to generate marketplace exchange recommendations in some embodiments of the UBGER. In some implementations, a UBGER server may obtain information about a user's behavior including, but not limited to: time ranges (see, e.g., 501) during which the user navigates the site (e.g., obtains web pages; play games; buys, sells or trades games; etc.); whether the user plays a single-user or multi-user game (see, e.g., 502); the genres of games that the user plays (see, e.g., 503); the client devices using which the user navigates sites associated with the UBGER (see, e.g., 504); the user with whom the user plays and trades games (see, e.g., 505); the locations from which the user navigates sites associated with the UBGER; etc. In some implementations, the UBGER may generate pair-wise correlations between each of the variables tracked for the user. For illustration, an example set of four pair-wise correlations is shown below:

User ID: john.q.public

| Independent | Dependent | Dependent | Dependent | Dependent |
|---|---|---|---|---|
| Variable | Variable 1 | Variable 2 | Variable 3 | Variable 4 |
| Device | Game Type | Genre | Location | Time |
| iPad | Single | Strategy | US 76503 | 6:00-8:00 pm local |
| | (65%) | (44%) | (95%) | (72%) |

It is contemplated that any attribute of a user, a user's usage of an online resource, and user IDs of users included in a social graph of the user may be utilized as a variable in such correlation analysis. Accordingly, in some implementations, the UBGER may generate recommendations based on any attribute of the user, the user's usage of an online resource, the user's social graph

FIGS. 6A-B show logic flow diagrams illustrating example aspects of analyzing gamer behavior in some embodiments of the UBGER, e.g., a Gamer Behavior Analysis (“GBA”) component. In some implementations, a UBGER a server may obtain a request to analyze the behavior of an individual. The server may parse the request and extract a user ID corresponding to the user for whom the request is made. The server may utilize the user ID to query a database for activity logs associated with the user ID. In some implementations, the server may extract data fields and values for trackable user attributes from each of the activity logs, and generate statistical correlation information associated with the user. For example, the server may select an activity log, and parse the activity logs to extract data fields and values associated with the fields, e.g., 605. For example, the server may utilize parsers such as those described below in the discussion with reference to FIG. 10. In some implementations, the server may identify a location of the device from the extracted data, e.g., 606. For example, the server may obtain an Internet Protocol (“IP”) address of a client utilized by the user, and may utilize an IP lookup service to determine a location for the user. The server may identify a device type for the client utilized by the user. For example, the server may obtain a Media Address Control (“MAC”) address for the client device, and may use the MAC address to identify a type of device (e.g., Apple MacBook, Sony PS3, Microsoft Xbox) through a lookup search. The server may also determine, e.g., 608, the type of activity that the log pertains to, e.g., a single-user game, multi-user game, trading activity, login, logout, navigation to a URL, etc. In some implementations, if the activity is a user login activity, e.g., 609, option “Yes,” the server may extract a timestamp, e.g., 610, associated with the login activity, and create a timekeeper, e.g., 611, to track the length of time for which the user was logged in to the service. If the activity is a user logout activity, e.g., 612, option “Yes,” the server may extract a timestamp associated with the logout, identify a timekeeper associate with the activity, and calculate a time for which the user was logged into the service using the start time for the timekeeper and the timestamp associated with the logout activity, e.g., 614.

In some implementations, if the activity is a site navigation activity, e.g., 615, option “Yes,” the server may extract a timestamp associated with the site navigation and a uniform resource locator (“URL”) associated with the site, e.g., 616. The server may query a database for a genre associated with the URL, e.g., 617. If the activity is a user gaming activity, e.g., 618, option “Yes,” such as a user action within a gaming app environment, the server may extract a timestamp associated with the user activity, e.g., 619. The server may query a database to determine a game title, game launch date, genre, user reviews, crowd-sourced ratings, critic reviews (e.g., such as Metacritic by CBS Interactive, Inc.), etc. for the game being played by the user, e.g., 620. The server may also query the database to determine whether the game is a single-user of multi-user game, e.g., 621. If the game is a multi-user game, e.g., 622, option “Yes,” the server may identify the user IDs of the other participants in the game, e.g., 623, and add the participants to a gaming social graph of the user, e.g., 624. Each participant added to the gaming social graph may then be utilized as a variable in the pair-wise correlation analysis. If the activity is a trading activity, e.g., 625, option “Yes,” the server may extract game ID(s) and a timestamp associated with the trading activity, e.g., 626. The server may extract game condition(s) (e.g., for a physical CD, whether the CD is new, used, good, etc.) for the game(s) being traded, e.g., 627. The server may extract a data flag indicating whether the trade includes a buy and a sell activity, e.g., 628, and a trade value for the game.

In some implementations, the server may identify, e.g., 629, a currency utilized for the trade, and may convert the value of the traded item(s) to a standard currency, e.g., US dollar. For example, the trade currency may be a currency system of a geopolitical entity, or may be virtual currency, rewards points, airline miles, and the like. In some implementations, the server may utilize the details of the trade to generate market data. Such market data may be utilized by the UBGER to generate recommendations for the user. The server may store the game ID, condition, trade currency, and standard currency value in a market database. In alternate implementations, the server may obtain such market data from an external market data source, such as Glyde. The server may also identify other trade participants, and add the participants to a trading social graph of the user. Each participant added to the gaming social graph may then be utilized as a variable in the pair-wise correlation analysis.

In some implementations, the server may utilize data such as the data described above to generate pair-wise variable correlations, e.g., 633, similar to the example provided above in the discussion with reference to FIG. 5. The server may utilize correlations obtained from the currently analyzed activity log to update the statistical correlations created from aggregating statistics from previously analyzed activity logs of the user, e.g., 634. The server may store the updated correlations aggregated across the activity logs associated with the user, e.g., 635. In some implementations, the server may analyze each activity log, until data from all activity logs associated with the user have been utilized to create pair-wise correlations between behavioral characteristics of the user (see, e.g., 604).

FIG. 7 shows a logic flow diagram illustrating example aspects of aggregating gaming statistics in some embodiments of the UBGER, e.g., an Aggregate Gaming Statistics Generation (“AGSG”) component. In some implementations, a UBGER server, may obtain a trigger to generate aggregate gaming statistics across users. In various implementations, the server may initiate generating or updating aggregate gaming statistics periodically, continuously, on-demand (e.g., when a user requests a recommendation), or according to a pre-determined schedule. The server may obtain a list of user IDs, for example querying a database. For each user in the list, see e.g., 704, the server may obtain, e.g., 705, previously generated pair-wise correlations between behavioral characteristic variables of that user, for example, as generated by the GBA 600 component discussed above with reference to FIG. 6. The server may select a variable pair from the previously generated pair-wise correlations, see e.g., 706. For the selected variable pair, the server may generate an updated aggregated pair-wise correlation across all the users by accounting for the presence of the selected variable pair among the variable pairs for the selected user, e.g., 707. The server may store the updated correlation value for the selected variable pair to a database, e.g., 708. The server may continue the updating of the aggregate pair-wise correlation across all users by performing the above process for each variable pair available for each user in the user ID list, see, e.g., 709-710.

FIGS. 8A-B show logic flow diagrams illustrating example aspects of generating buy recommendations in some embodiments of the UBGER, e.g., Buy Recommendation Generation (“BRG”) components. In some implementations, a server within the UBGER may obtain a trigger to generate a buy recommendation for a user. The server may obtain a timestamp associated with the user, e.g., 802. The server may also identify attributes of a device of the user such as the device type and location, e.g., 803. The server may then use the pair-wise variable correlations for the user to determine attributes of games that the user is most likely to play using the identified device during a time corresponding to the timestamp. For example, the server may query a database for a list of game types (e.g., mobile/desktop app, genre, single/multi-user, etc.) using the device attributes and timestamp as search terms, e.g., 804. The server may obtain a list of games satisfying the game type attributes by querying a database using the game types as search terms. From this list, the server may eliminate those games that are already accessible by the user, e.g., 806. In some implementations, the server may assign priorities to the games remaining in the list. For example, the server may rate games that are played by members of the user's gaming social graph higher than those not played by the social graph members, e.g., 807-808. As another example, the server may rate games that are played by more members of the user's social graph higher than those that are played less. As another example, the server may rate games that are played for longer periods of time by members of the user's social graph higher than those that are played for shorter periods of time. As another example, the server may rate games that have higher user reviews, crowd-sourced ratings, critic scores, or Metacritic scores as obtained from a database (see element 620 of FIG. 6) higher than other games.

In some implementations, the server may obtain market values for the games remaining in the list. For example, the server may obtain the market data from the activity logs of users (see e.g., element 628 of FIG. 6). Alternatively, the server may obtain market data for the games in the list from an external market data source such as Glyde. In some implementations, the server may generate a buy recommendation offer using the games in the list and their associated market values. In other implementations, the server may generate a trade offer recommending that the user buy a game and trade in a game that the user owns. For example, the server may obtain sell recommendations, for example, by executing a component such as the SRG 910/920 components described below in the discussion with reference to FIGS. 9A-B. In such implementations, the server may generate buy offers with a trade-in option using the game ID list, the market values, and the sell recommendations.

With reference to FIG. 8B, in some implementations, the server may generate buy or sell recommendations according to pre-specified rules stored in a database. For example, the server may obtain, e.g., 821, the activity data extracted from the user's activity logs, as well as pair-wise correlation data generated by analyzing the activity logs of the user (see FIGS. 6A-b). The server may obtain, e.g., 822, recommendation generation rules specifying ID(s), genres or other characteristics of games to be selected for recommendation if the rule is satisfied. An example illustrative recommendation rule encoded according to the eXtensible Markup Language (“XML”) is provided below:

```
<recommendation_rule>
  <id>BJ1234_sell</id>
  <name>blakjack_sell</name>
  <inputs>strategygenre_time strategygenre_numfriends</inputs>
  <operations>
    <1>result = ′ null′ ; score = ′ 0′ </1>
    <2>weighting = DB_LOOKUP(BJ1234_weight)</2>
    <3>score = strategygenre_time + weight*strategygenre_
    numfriends</3>
    <4>IF (score > threshold) result = ′ sell_gameid1234′ </2>
  </operations>
  <outputs>score result</outputs>
</recommendation_rule>
```

The recommendation generation rules may embody a variety of schemes for selecting games for buy/sell recommendations. As an example, a rule may specify that if the frequency of the user's visits to a webpage displaying games of a specific genre is among the top five of such frequencies, then a game of that genre be presented to the user as a buy recommendation. As another example, if the amount of time a user spends playing a game in a predetermined interval of time is greater than a threshold value, then a game of that genre may be presented to the user as a buy recommendation. Similarly, if the amount of time a user spends playing a game in a predetermined interval of time is less than a threshold value, then that genre may be presented to the user as a sell recommendation. As another example, if a game owned by the user has user reviews, crowd-sourced ratings, critic scores, or Metacritic scores higher than a threshold value, the server may select the game may be presented to the user as a sell recommendation.

In some implementations, the server may select a recommendation generation rule for processing, e.g., 823. The server may parse the rule, and extract a listing of the inputs required to process the rule, e.g., 824. According to the input list, the server may parse the activity data of the user to obtain the inputs required to process the rule, e.g., 825. The server may parse the rule to obtain a listing of the operations to be performed on the inputs, as well as a listing of the outputs from the processing of the rule, e.g., 826. The server may perform the computations as specified in the listing of operations, and generate the required outputs, e.g., 827, such as a rule score. The server may also obtain thresholds that the rule score to overcome for the rule to be satisfied, e.g., 828. The server may compare the rule score with the rule threshold, e.g., 829. If the rule score overcomes the threshold, e.g., 830, option “Yes,” the server may add the game ID(s) associated with the rule to a buy/sell queue, e.g., 831. The server may repeat the above procedure for all the recommendation generation rules that are available for processing, see e.g., 832. Upon processing all of the recommendation generation rules, the server may sort the games in the buy/sell queues according to their associated rule scores, e.g., 833. The server may obtain market values for the games in the queues, e.g., 834, and generate a buy recommendation offer using the games in the list and their associated market values. In some implementations, the server may generate a trade offer recommending that the user buy a game and trade in a game that the user owns. For example, the server may obtain sell recommendations, for example, by executing a component such as the SRG 910/920 components described below in the discussion with reference to FIGS. 9A-B. In such implementations, the server may generate buy offers with a trade-in option using the game ID list, the market values, and the sell recommendations.

FIGS. 9A-B show logic flow diagrams illustrating example aspects of generating sell recommendations in some embodiments of the UBGER, e.g., Sell Recommendation Generation (“SRG”) components. In some implementations, a server within the UBGER may obtain a trigger to generate a sell recommendation for a user, e.g., 901. The server may obtain a timestamp associated with the user, e.g., 902. The server may also obtain a list of games owned by a user, for example by querying a database, e.g., 903. For each game, the server may calculate an aggregate usage amount, e.g., 904, using the aggregated correlation data for the user. For example, the server may determine how much each game has been utilized over a pre-determined prior duration of time (e.g., past month, past month, past year, etc.). The server may sort the games in the list in increasing order of aggregate usage, e.g., 905, such that the least used games are most likely to be included in a sell recommendation. As another example, the server may further sort the games according to their user review scores, crowd-sourced ratings, critic scores, or Metacritic scores.

In some implementations, the server may obtain market values for the games remaining in the list, e.g., 906. For example, the server may obtain the market data from the activity logs of users (see e.g., element 628 of FIG. 6). Alternatively, the server may obtain market data for the games in the list from an external market data source such as Glyde. In some implementations, the server may generate a sell recommendation offer using the games in the list and their associated market values. In other implementations, the server may generate a trade offer recommending that the user buy a game and trade in a game that the user owns. For example, the server may obtain buy recommendations, for example, by executing a component such as the BRG 800 component described above in the discussion with reference to FIG. 8. In such implementations, the server may generate sell offers with a trade option using the game ID list, the market values, and the buy recommendations.

In alternate implementations, the server may generate time-dependent activity rate graphs tracking the user's usage of games owned by the user, and determine which games owned by the user to recommend for sale based on their associated activity rate graphs. The server within the UBGER may obtain a trigger to generate a sell recommendation for a user, e.g., 911. The server may obtain a timestamp associated with the user, e.g., 912. The server may also obtain a list of games owned by a user, for example by querying a database, e.g., 913. For each game, the server may generate a time-dependent activity graph, e.g., 914. For example, the server may plot the amount of usage of a game per day over time in days (see activity graph 920), for each game owned by the user. The server may then, for each game, calculate a time lapse since the activity rate of the user for that game fell below a predetermined threshold, e.g., 914, using the aggregated correlation data for the user. The server may sort the games in the list in decreasing order of the time lapse, e.g., 916, such that the games that have not been used much for the greatest amount of time lapse are most likely to be included in a sell recommendation. The server may obtain market values for the games remaining in the list, e.g., 916. The server may generate a sell recommendation offer using the games in the list and their associated market values. In other implementations, the server may generate a trade offer recommending that the user buy a game and trade in a game that the user owns. In such implementations, the server may generate sell offers with a trade option using the game ID list, the market values, and the buy recommendations, see e.g., 918-19.

### UBGER Controller

FIG. 10 illustrates inventive aspects of a UBGER controller 1001 in a block diagram. In this embodiment, the UBGER controller 1001 may serve to aggregate, process, store, search, serve, identify, instruct, generate, match, and facilitate interactions with a computer through various technologies, and other related data.

Typically, users, which may be people and other systems, may engage information technology systems (e.g., computers) to facilitate information processing. In turn, computers employ processors to process information; such processors 1003 may be referred to as central processing units (CPU). One form of processor is referred to as a microprocessor. CPUs use communicative circuits to pass binary encoded signals acting as instructions to enable various operations. These instructions may be operational and data instructions containing and referencing other instructions and data in various processor accessible and operable areas of memory 1029 (e.g., registers, cache memory, random access memory, etc.). Such communicative instructions may be stored and transmitted in batches (e.g., batches of instructions) as programs and data components to facilitate desired operations. These stored instruction codes, e.g., programs, may engage the CPU circuit components and other motherboard and system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the UBGER controller 1001 may be connected to and communicate with entities such as, but not limited to: one or more users from user input devices loll; peripheral devices 1012; an optional cryptographic processor device 1028; and a communications network 1013. For example, the UBGER controller 1001 may be connected to and communicate with users operating client device(s) including, but not limited to, personal computer(s), server(s) and various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and combination thereof that is capable of processing and making requests and obtaining and processing any responses from servers across a communications network. A computer, other device, program, or combination thereof that facilitates, processes information and requests, and furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The UBGER controller 1001 may be based on computer systems that may comprise, but are not limited to, components such as: a computer systemization 1002 connected to memory 1029.

### Computer Systemization

A computer systemization 1002 may comprise a clock 1030, central processing unit (“CPU(s)” and “processor(s)” (these terms are used interchangeable throughout the disclosure unless noted to the contrary)) 1003, a memory 1029 (e.g., a read only memory (ROM) 1006, a random access memory (RAM) 1005, etc.), and an interface bus 1007, and most frequently, although not necessarily, are all interconnected and communicating through a system bus 1004 on one or more (mother)board(s) 1002 having conductive and otherwise transportive circuit pathways through which instructions (e.g., binary encoded signals) may travel to effect communications, operations, storage, etc. Optionally, the computer systemization may be connected to an internal power source 1086. Optionally, a cryptographic processor 1026 and transceivers (e.g., ICs) 1074 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and reply communications beyond the instant computer systemization to: communications networks, input devices, other computer systemizations, peripheral devices, and the like. Of course, any of the above components may be connected directly to one another, connected to the CPU, and organized in numerous variations employed as exemplified by various computer systems.

The CPU comprises at least one high-speed data processor adequate to execute program components for executing user and system-generated requests. Often, the processors themselves will incorporate various specialized processing units, such as, but not limited to: integrated system (bus) controllers, memory management control units, floating point units, and even specialized processing sub-units like graphics processing units, digital signal processing units, and the like. Additionally, processors may include internal fast access addressable memory, and be capable of mapping and addressing memory 1029 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and Opteron; ARM's application, embedded and secure processors; IBM and Motorola's DragonBall and PowerPC; IBM's and Sony's Cell processor; Intel's Celeron, Core (2) Duo, Itanium, Pentium, Xeon, and XScale; and the like processor(s). The CPU interacts with memory through instruction passing through conductive and transportive conduits (e.g., (printed) electronic and optic circuits) to execute stored instructions (i.e., program code) according to conventional data processing techniques. Such instruction passing facilitates communication within the UBGER controller and beyond through various interfaces. Should processing requirements dictate a greater amount speed and capacity, distributed processors (e.g., Distributed UBGER), mainframe, multi-core, parallel, and super-computer architectures may similarly be employed. Alternatively, should deployment requirements dictate greater portability, smaller Personal Digital Assistants (PDAs) may be employed.

Depending on the particular implementation, features of the UBGER may be achieved by implementing a microcontroller such as CAST's R8051XC2 microcontroller; Intel's MCS 51 (i.e., 8051 microcontroller); and the like. Also, to implement certain features of the UBGER, some feature implementations may rely on embedded components, such as: Application-Specific Integrated Circuit (“ASIC”), Digital Signal Processing (“DSP”), Field Programmable Gate Array (“FPGA”), and the like embedded technology. For example, any of the UBGER component collection (distributed or otherwise) and features may be implemented via the microprocessor and via embedded components; e.g., via ASIC, coprocessor, DSP, FPGA, and the like. Alternately, some implementations of the UBGER may be implemented with embedded components that are configured and used to achieve a variety of features or signal processing.

Depending on the particular implementation, the embedded components may include software solutions, hardware solutions, and some combination of both hardware/software solutions. For example, UBGER features discussed herein may be achieved through implementing FPGAs, which are a semiconductor devices containing programmable logic components called “logic blocks”, and programmable interconnects, such as the high performance FPGA Virtex series and the low cost Spartan series manufactured by Xilinx. Logic blocks and interconnects can be programmed by the customer or designer, after the FPGA is manufactured, to implement any of the UBGER features. A hierarchy of programmable interconnects allow logic blocks to be interconnected as needed by the UBGER system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the UBGER may be developed on regular FPGAs and then migrated into a fixed version that more resembles ASIC implementations. Alternate or coordinating implementations may migrate UBGER controller features to a final ASIC instead of or in addition to FPGAs. Depending on the implementation all of the aforementioned embedded components and microprocessors may be considered the “CPU” and “processor” for the UBGER.

### Power Source

The power source 1086 may be of any standard form for powering small electronic circuit board devices such as the following power cells: alkaline, lithium hydride, lithium ion, lithium polymer, nickel cadmium, solar cells, and the like. Other types of AC or DC power sources may be used as well. In the case of solar cells, in one embodiment, the case provides an aperture through which the solar cell may capture photonic energy. The power cell 1086 is connected to at least one of the interconnected subsequent components of the UBGER thereby providing an electric current to all subsequent components. In one example, the power source 1086 is connected to the system bus component 1004. In an alternative embodiment, an outside power source 1086 is provided through a connection across the I/O 1008 interface. For example, a USB and IEEE 1394 connection carries both data and power across the connection and is therefore a suitable source of power.

### Interface Adapters

Interface bus(ses) 1007 may accept, connect, and communicate to a number of interface adapters, conventionally although not necessarily in the form of adapter cards, such as but not limited to: input output interfaces (I/O) 1008, storage interfaces 1009, network interfaces 1010, and the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

Storage interfaces 1009 may accept, communicate, and connect to a number of storage devices such as, but not limited to: storage devices 1014, removable disc devices, and the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and the like.

Network interfaces 1010 may accept, communicate, and connect to a communications network 1013. Through a communications network 1013, the UBGER controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and the like), Token Ring, wireless connection such as IEEE 802.11a-x, and the like. Should processing requirements dictate a greater amount speed and capacity, distributed network controllers (e.g., Distributed UBGER), architectures may similarly be employed to pool, load balance, and otherwise increase the communicative bandwidth required by the UBGER controller. A communications network may be any one and the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and the like); and the like. A network interface may be regarded as a specialized form of an input output interface. Further, multiple network interfaces 1010 may be used to engage with various communications network types 1013. For example, multiple network interfaces may be employed to allow for the communication over broadcast, multicast, and unicast networks.

Input Output interfaces (I/O) 1008 may accept, communicate, and connect to user input devices 1011, peripheral devices 1012, cryptographic processor devices 1028, and the like. I/O may employ connection protocols such as, but not limited to: audio: analog, digital, monaural, RCA, stereo, and the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.; and the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors, styluses, and the like.

Peripheral devices 1012 may be connected and communicate to I/O and other facilities of the like such as network interfaces, storage interfaces, and the like. Peripheral devices may be external, internal and part of the UBGER controller. Peripheral devices may include: antenna, audio devices, cameras (e.g., still, video, webcam, etc.), dongles (e.g., for copy protection, ensuring secure transactions with a digital signature, and the like), external processors (for added capabilities; e.g., crypto devices 1028), network interfaces, printers, scanners, storage devices, video devices, video sources, visors, and the like.

It should be noted that although user input devices and peripheral devices may be employed, the UBGER controller may be embodied as an embedded, dedicated, and monitor-less (i.e., headless) device, wherein access would be provided over a network interface connection.

Cryptographic units such as, but not limited to, microcontrollers, processors 1026, interfaces 1027, and devices 1028 may be attached, and communicate with the UBGER controller. A MC68HC16 microcontroller, manufactured by Motorola Inc., may be used for and within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and the like.

### Memory

Generally, any mechanization and embodiment allowing a processor to affect the storage and retrieval of information is regarded as memory 1029. However, memory is a fungible technology and resource, thus, any number of memory embodiments may be employed in lieu of or in concert with one another. It is to be understood that the UBGER controller and a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and other devices of the like. Thus, a computer systemization generally requires and makes use of memory.

### Component Collection

The memory 1029 may contain a collection of program and database components and data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); the UBGER component(s) 1035; and the like (i.e., collectively a component collection). These components may be stored and accessed from the storage devices and from storage devices accessible through an interface bus. Although non-conventional program components such as those in the component collection, typically, are stored in a local storage device 1014, they may also be loaded and stored in memory such as: peripheral devices, RAM, remote storage facilities through a communications network, ROM, various forms of memory, and the like.

### Operating System

The operating system component 1015 is an executable program component facilitating the operation of the UBGER controller. Typically, the operating system facilitates access of I/O, network interfaces, peripheral devices, storage devices, and the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and the like; Linux distributions such as Red Hat, Ubuntu, and the like); and the like operating systems. However, more limited and less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and the like. An operating system may communicate to and with other components in a component collection, including itself, and the like. Most frequently, the operating system communicates with other program components, user interfaces, and the like. For example, the operating system may contain, communicate, generate, obtain, and provide program component, system, user, and data communications, requests, and responses. The operating system, once executed by the CPU, may enable the interaction with communications networks, data, I/O, peripheral devices, program components, memory, user input devices, and the like. The operating system may provide communications protocols that allow the UBGER controller to communicate with other entities through a communications network 1013. Various communication protocols may be used by the UBGER controller as a subcarrier transport mechanism for interaction, such as, but not limited to: multicast, TCP/IP, UDP, unicast, and the like.

### Information Server

An information server component 1016 is a stored program component that is executed by a CPU. The information server may be a conventional Internet information server such as, but not limited to Apache Software Foundation's Apache, Microsoft's Internet Information Server, and the like. The information server may allow for the execution of program components through facilities such as Active Server Page (ASP), ActiveX, (ANSI) (Objective-) C (++), C# and .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the UBGER controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and the like. An information server may communicate to and with other components in a component collection, including itself, and facilities of the like. Most frequently, the information server communicates with the UBGER database 1019, operating systems, other program components, user interfaces, Web browsers, and the like.

Access to the UBGER database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the UBGER. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and fields. In one embodiment, the parser may generate queries in standard SQL by instantiating a search string with the proper join/select commands based on the tagged text entries, wherein the resulting command is provided over the bridge mechanism to the UBGER as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and provide program component, system, user, and data communications, requests, and responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1017 is a stored program component that is executed by a CPU. The user interface may be a conventional graphic user interface as provided by, with, and atop operating systems and operating environments such as already discussed. The user interface may allow for the display, execution, interaction, manipulation, and operation of program components and system facilities through textual and graphical facilities. The user interface provides a facility through which users may affect, interact, and operate a computer system. A user interface may communicate to and with other components in a component collection, including itself, and facilities of the like. Most frequently, the user interface communicates with operating systems, other program components, and the like. The user interface may contain, communicate, generate, obtain, and provide program component, system, user, and data communications, requests, and responses.

### Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and the like. Web browsers allowing for the execution of program components through facilities such as ActiveX, AJAX, (D)HTML, FLASH, Java, JavaScript, web browser plug-in APIs (e.g., Firefox, Safari Plug-in, and the like APIs), and the like. Web browsers and like information access tools may be integrated into PDAs, cellular telephones, and other mobile devices. A Web browser may communicate to and with other components in a component collection, including itself, and facilities of the like. Most frequently, the Web browser communicates with information servers, operating systems, integrated program components (e.g., plug-ins), and the like; e.g., it may contain, communicate, generate, obtain, and provide program component, system, user, and data communications, requests, and responses. Of course, in place of a Web browser and information server, a combined application may be developed to perform similar functions of both. The combined application would similarly affect the obtaining and the provision of information to users, user agents, and the like from the UBGER enabled nodes. The combined application may be nugatory on systems employing standard Web browsers.

### Mail Server

A mail server component 1021 is a stored program component that is executed by a CPU 1003. The mail server may be a conventional Internet mail server such as, but not limited to sendmail, Microsoft Exchange, and the like. The mail server may allow for the execution of program components through facilities such as ASP, ActiveX, (ANSI) (Objective-) C (++), C# and .NET, CGI scripts, Java, JavaScript, PERL, PHP, pipes, Python, WebObjects, and the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and the like. The mail server can route, forward, and process incoming and outgoing mail messages that have been sent, relayed and otherwise traversing through and to the UBGER.

Access to the UBGER mail may be achieved through a number of APIs offered by the individual Web server components and the operating system.

Also, a mail server may contain, communicate, generate, obtain, and provide program component, system, user, and data communications, requests, information, and responses.

### Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla, Thunderbird, and the like. Mail clients may support a number of transfer protocols, such as: IMAP, Microsoft Exchange, POP3, SMTP, and the like. A mail client may communicate to and with other components in a component collection, including itself, and facilities of the like. Most frequently, the mail client communicates with mail servers, operating systems, other mail clients, and the like; e.g., it may contain, communicate, generate, obtain, and provide program component, system, user, and data communications, requests, information, and responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and the like. Cryptographic processor interfaces will allow for expedition of encryption and decryption requests by the cryptographic component; however, the cryptographic component, alternatively, may run on a conventional CPU. The cryptographic component allows for the encryption and decryption of provided data. The cryptographic component allows for both symmetric and asymmetric (e.g., Pretty Good Protection (PGP)) encryption and decryption. The cryptographic component may employ cryptographic techniques such as, but not limited to: digital certificates (e.g., X.509 authentication framework), digital signatures, dual signatures, enveloping, password access protection, public key management, and the like. The cryptographic component will facilitate numerous (encryption and decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and the like. Employing such encryption security protocols, the UBGER may encrypt all incoming and outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and with other components in a component collection, including itself, and facilities of the like. The cryptographic component supports encryption schemes allowing for the secure transmission of information across a communications network to enable the UBGER component to engage in secure transactions if so desired. The cryptographic component facilitates the secure accessing of resources on the UBGER and facilitates the access of secured resources on remote systems; i.e., it may act as a client and server of secured resources. Most frequently, the cryptographic component communicates with information servers, operating systems, other program components, and the like. The cryptographic component may contain, communicate, generate, obtain, and provide program component, system, user, and data communications, requests, and responses.

### The UBGER Database

The UBGER database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the UBGER database may be implemented using various standard data-structures, such as an array, hash, (linked) list, struct, structured text file (e.g., XML), table, and the like. Such data-structures may be stored in memory and in (structured) files. In another alternative, an object-oriented database may be used, such as Frontier, ObjectStore, Poet, Zope, and the like. Object databases can include a number of object collections that are grouped and linked together by common attributes; they may be related to other object collections by some common attributes. Object-oriented databases perform similarly to relational databases with the exception that objects are not just pieces of data but may have other types of functionality encapsulated within a given object. If the UBGER database is implemented as a data-structure, the use of the UBGER database 1019 may be integrated into another component such as the UBGER component 1035. Also, the database may be implemented as a mix of data structures, objects, and relational structures. Databases may be consolidated and distributed in countless variations through standard data processing techniques. Portions of databases, e.g., tables, may be exported and imported and thus decentralized and integrated.

In one embodiment, the database component 1019 includes several tables 1019a-l. A Users table 1019a may include fields such as, but not limited to: user_id, user_name, billing_address, shipping_address, zipcode, contact info, and the like. The Users table may support and track multiple entity accounts on a UBGER. A Clients table 1019b may include fields such as, but not limited to: user_id, client_id, client_type, client_IP, client_MAC, client_OS, hardware_list, software_compatibilities_list, and the like. A Gaming Data table 1019c may include fields such as, but not limited to: game_id, game_name, game_type, game_condition, game_genre, game_hardware_req, game_software_requirements, market_value, and the like. An Activity Logs table 1019d may include fields such as, but not limited to: user_id, activity_type, activity_value, timestamp, and the like. A Behavior Rules table 1019e may include fields such as, but not limited to: rule_id, rule_type, rule_name, inputs, process_steps, outputs, and the like. A Statistics Generation Rules table 1019f may include fields such as, but not limited to: rule_id, rule_type, rule_name, inputs, process_steps, outputs, and the like. A Recommendation Rules table 1019g may include fields such as, but not limited to: rule_id, rule_type, rule_name, inputs, process_steps, outputs, and the like. A Presentation Rules table 1019h may include fields such as, but not limited to: rule_id, rule_type, rule_name, inputs, process_steps, outputs, and the like. An Exchange Offers table 1019i may include fields such as, but not limited to: offer_id, offer_name, creator, timestamp, last_modified, expiry, and the like. An Exchange Rates table 1019j may include fields such as, but not limited to: currency_id, currency_name, currency_type, value, and the like. A User Privacy Rules table 1019k may include fields such as, but not limited to: rule_id, rule_type, rule_name, inputs, process_steps, outputs, and the like. A Market Data table 10191 may include fields such as, but not limited to: market_data_feed_ID, asset_ID, asset_symbol, asset_name, spot_price, bid_price, ask_price, and the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, the UBGER database may interact with other database systems. For example, employing a distributed database system, queries and data access by search UBGER component may treat the combination of the UBGER database, an integrated data security layer database as a single database entity.

In one embodiment, user programs may contain various user interface primitives, which may serve to update the UBGER. Also, various accounts may require custom database tables depending upon the environments and the types of clients the UBGER may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and storage devices. Similarly, configurations of the decentralized database controllers may be varied by consolidating and distributing the various database components 1019a-l. The UBGER may be configured to keep track of various settings, inputs, and parameters via database controllers.

The UBGER database may communicate to and with other components in a component collection, including itself, and facilities of the like. Most frequently, the UBGER database communicates with the UBGER component, other program components, and the like. The database may contain, retain, and provide information regarding other nodes and data.

### The UBGERs

The UBGER component 1035 is a stored program component that is executed by a CPU. In one embodiment, the UBGER component incorporates any and all combinations of the aspects of the UBGER discussed in the previous figures. As such, the UBGER affects accessing, obtaining and the provision of information, services, transactions, and the like across various communications networks.

The UBGER component may transform user site navigation inputs via UBGER components into systematically-defined user behavior-based game exchange recommendations and offers, and the like and use of the UBGER. In one embodiment, the UBGER component 1035 takes inputs (e.g., site input 311, gaming data 316, site input 414, buy recommendations 418, user activity logs 411, user inactive games list 421, market value data 423, and the like) etc., and transforms the inputs via various components (e.g., GAT component 1041, GBA component 1042, AGSG component 1043, BRG component 1044, SRG component 1045, ATGM component 1046, and the like), into outputs (e.g., activity log 319, server response 320, buy/sell recommendation presentations 425, and the like).

The UBGER component enabling access of information between nodes may be developed by employing standard development tools and languages such as, but not limited to: Apache components, Assembly, ActiveX, binary executables, (ANSI) (Objective-) C (++), C# and .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and the like), WebObjects, and the like. In one embodiment, the UBGER server employs a cryptographic server to encrypt and decrypt communications. The UBGER component may communicate to and with other components in a component collection, including itself, and facilities of the like. Most frequently, the UBGER component communicates with the UBGER database, operating systems, other program components, and the like. The UBGER may contain, communicate, generate, obtain, and provide program component, system, user, and data communications, requests, and responses.

### Distributed UBGERs

The structure and operation of any of the UBGER node controller components may be combined, consolidated, and distributed in any number of ways to facilitate development and deployment. Similarly, the component collection may be combined in any number of ways to facilitate deployment and development. To accomplish this, one may integrate the components into a common code base or in a facility that can dynamically load the components on demand in an integrated fashion.

The component collection may be consolidated and distributed in countless variations through standard data processing and development techniques. Multiple instances of any one of the program components in the program component collection may be instantiated on a single node, and across numerous nodes to improve performance through load-balancing and data-processing techniques. Furthermore, single instances may also be distributed across multiple controllers and storage devices; e.g., databases. All program component instances and controllers working in concert may do so through standard data processing communication techniques.

The configuration of the UBGER controller will depend on the context of system deployment. Factors such as, but not limited to, the budget, capacity, location, and use of the underlying hardware resources may affect deployment requirements and configuration. Regardless of if the configuration results in more consolidated and integrated program components, results in a more distributed series of program components, and results in some combination between a consolidated and distributed configuration, data may be communicated, obtained, and provided. Instances of components consolidated into a common code base from the program component collection may communicate, obtain, and provide data. This may be accomplished through intra-application data processing communication techniques such as, but not limited to: data referencing (e.g., pointers), internal messaging, object instance variable communication, shared memory space, variable passing, and the like.

If component collection components are discrete, separate, and external to one another, then communicating, obtaining, and providing data with and to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and the like), Common Object Request Broker Architecture (CORBA), Jini local and remote application program interfaces, JavaScript Object Notation (JSON), Remote Method Invocation (RMI), SOAP, process pipes, shared files, and the like. Messages sent between discrete component components for inter-application communication or within memory spaces of a singular component for intra-application communication may be facilitated through the creation and parsing of a grammar. A grammar may be developed by using development tools such as lex, yacc, XML, and the like, which allow for grammar generation and parsing capabilities, which in turn may form the basis of communication messages within and between components.

For example, a grammar may be arranged to recognize the tokens of an HTTP post command, e.g.:

w3c -post http:// . . . Value1

Where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and otherwise used to generate the parsing mechanism (e.g., a syntax description text file as processed by lex, yacc, etc.). Also, once the parsing mechanism is generated and instantiated, it itself may process and parse structured data such as, but not limited to: character (e.g., tab) delineated text, HTML, structured text streams, XML, and the like structured data. In another embodiment, inter-application data processing protocols themselves may have integrated and readily available parsers (e.g., JSON, SOAP, and like parsers) that may be employed to parse (e.g., communications) data. Further, the parsing grammar may be used beyond message parsing, but may also be used to parse: databases, data collections, data stores, structured data, and the like. Again, the desired configuration will depend upon the context, environment, and requirements of system deployment.

For example, in some implementations, the UBGER controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(′Content-Type: text/plain′);
// set ip address and port to listen to for incoming data $address =
′192.168.0.100′; $port = 255;
// create a server-side SSL socket, listen for/accept incoming communication
$sock = socket_create(AF_INET, SOCK_STREAM, 0); socket_bind($sock,
$address, $port) or die(′ Could not bind to address′ ); socket_listen($sock);
$client = socket_accept($sock);
// read input data from client device in 1024 byte blocks until end of message do {
  $input = ″″;
    $input = socket_read($client, 1024);
    $data .= $input;
} while($input != ″″);
// parse data to extract variables $obj = json_decode($data, true);
// store input data in a database
mysql_connect(″201.408.185.132″,$DBserver,$password); // access database
server mysql_select(″CLIENT_DB.SQL″); // select database to append
mysql_query(″INSERT INTO UserTable (transmission) VALUES ($data)″); // add
data to UserTable table in a CLIENT database mysql_close(″CLIENT_DB.SQL″); //
close connection to database
?>
```

Also, the following resources may be used to provide example embodiments regarding SOAP parser implementation and other parser implementations, all of which are hereby expressly incorporated by reference:

[1] http://www.xav.com/perl/site/lib/SOAP/Parser.html
[2] http://www.publib.boulder.ibm.com/infocenter/tivihelp/v2r1/
index.jsp?topic=/com.ibm.IBMDI.doc/referenceguide295.htm
[3] http://publib.boulder.ibm.com/infocenter/tivihelp/v2r1/
index.jsp?topic=/com.ibm.IBMDI.doc/referenceguide259.htm

In order to address various issues and advance the art, the entirety of this application for GAMING MARKETPLACE APPARATUSES, METHODS AND SYSTEMS (including the Cover Page, Title, Headings, Field, Background, Summary, Brief Description of the Drawings, Detailed Description, Claims, Abstract, Figures, Appendices and otherwise) shows by way of illustration various embodiments in which the claimed inventions may be practiced. The advantages and features of the application are of a representative sample of embodiments only, and are not exhaustive and exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and topological modifications may be made without departing from the scope and spirit of the disclosure. As such, all examples and embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and topological structure of any combination of any program components (a component collection), other components and any present feature sets as described in the figures and throughout are not limited to a fixed operating order and arrangement, but rather, any disclosed order is exemplary and all equivalents, regardless of order, are contemplated by the disclosure. Furthermore, it is to be understood that such features are not limited to serial execution, but rather, any number of threads, processes, services, servers, and the like that may execute asynchronously, concurrently, in parallel, simultaneously, synchronously, and the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and the like thereof. As such, it should be understood that advantages, embodiments, examples, functional, features, logical, organizational, structural, topological, and other aspects of the disclosure are not to be considered limitations on the disclosure as defined by the claims or limitations on equivalents to the claims. It is to be understood that, depending on the particular needs and characteristics of a UBGER individual and enterprise user, database configuration and relational model, data type, data transmission and network framework, syntax structure, and the like, various embodiments of the UBGER may be implemented that enable a great deal of flexibility and customization. For example, aspects of the UBGER may be adapted for in-game virtual goods purchasing, (electronic) books exchanges, financial trading systems, portfolio management, media sharing, and the like. While various embodiments and discussions of the UBGER have been directed to game-related marketplace transactions, however, it is to be understood that the embodiments described herein may be readily configured and customized for a wide variety of other applications and implementations.

What is claimed is:

1. A computer-implemented method of presenting electronic gaming transaction recommendations and offers, the method performed by one or more servers of an online gaming marketplace service and comprising:
receiving, from a client device, a navigation request;
parsing the navigation request to determine a user identifier associated with a user of the client device;
based on the user identifier, accessing an activity database to identify a plurality of activity logs associated with the user, wherein the plurality of activity logs comprises usage characteristics corresponding to types of games the user plays, electronic games to which the user has access, a gaming device used to play the accessible electronic games, and timestamps for gameplay of the accessible electronic games;
based at least in part on the usage characteristics, generating a number of recommendations to buy one or more new electronic games, sell one or more of the accessible electronic games, or trade one or more of the accessible electronic games;
generating a multi-component user interface comprising the generated recommendations; and
sending the multi-component user interface to the client device for presentation.

2. The method of claim 1, wherein the navigation request comprises a plurality of data fields including the user identifier and an instruction to process a buy, sell, or trade transaction.

3. The method of claim 1, further comprising:
identifying, based on the timestamps for game play, one or more inactive games, from the accessible electronic games, that the user has not accessed for a predetermined period of time; and
determining, from a game database, a market value for each of the one or more inactive games.

4. The method of claim 3, further comprising:
based on the types of games the user plays and the gaming device used to play the accessible electronic games, generating a recommendation to buy a specified electronic game, the specified electronic game being of a genre indicated by the types of games the user plays, and being compatible with the gaming device;
determining, from the game database, a market value for the specified electronic game; and
including the recommendation to buy the specified electronic game, and a purchase price corresponding to the market value for the specified electronic game, on the generated multi-component user interface.

5. The method of claim 4, wherein the types of games the user plays indicates a preferred game genre and whether the user prefers single player or multi-player electronic games, and wherein the specified game is recommended for purchase in accordance with the preferred genre and the user's preference of either single player or multi-player.

6. The method of claim 1, wherein the one or more servers aggregate additional usage characteristics for the user in a new activity log based on a trigger event, and wherein the trigger event comprises one or more of: a login of the user, a logoff of the user, a navigation event of the user, a website request by the user, a trading activity of the user, an in-game event for a game played by the user, execution of client-side code resulting from a user action, and execution of server-side code resulting from a user action.

7. The method of claim 3, further comprising:
generating a recommendation to sell at least one of the one or more inactive games; and
including the recommendation to sell the at least one of the one or more inactive games, and a sale value corresponding to the market value for the at least one of the one or more inactive games, on the generated multi-component user interface.

8. The method of claim 3, further comprising:
identifying, from the activity database, a number of flagged trade-in games owned by other users of the online gaming marketplace service;
determining that a specified one of the flagged trade-in games satisfy the types of games the user plays and is compatible with the gaming device;
generating a recommendation to trade at least one of the one or more inactive games for the specified flagged trade-in game; and
including the recommendation to trade the at least one of the one or more inactive games for the specified flagged trade-in game on the generated multi-component user interface.

9. The method of claim 4, wherein generating the recommendation to buy the specified electronic game further includes generating a recommendation to trade at least one of the one or more inactive games, and wherein the purchase price for the specified game further reflects a trade-in value of the at least one of the one or more inactive games.

10. The method of claim 1, wherein generating a multi-component user interface further includes generating a modification feature to enable the user to modify one or more displayed data items of the multi-component user interface, and wherein user interaction with the modification feature causes the one or more servers to update the multi-component user interface in accordance with the one or more modified data items.

11. The method of claim 2, wherein the plurality of data fields indicates current display characteristics of the client device, the method further comprising:
prior to sending the multi-component user interface to the client device for presentation, formatting the multi-component user interface to reflect the current display characteristics of the client device.

12. The method of claim 11, wherein the current display characteristics of the client device indicate that the user is currently playing a game on the client device, and wherein the multi-component user interface is formatted to provide a real-time modification of the currently played game in presenting the multi-component user interface to the client device.

13. The method of claim 1, further comprising:
prior to generating the number of recommendations, querying a game database for game titles, game launch dates, gaming genres, user game reviews, crowd-sourced game ratings, and critic reviews for games based on the usage characteristics;
wherein the generated recommendations are further based on results of the query.

14. A non-transitory computer-readable medium storing instructions for presenting electronic gaming transaction recommendations and offers, wherein the instructions, when executed by one or more servers of an online gaming marketplace service, cause the one or more servers to:
receive, from a client device, a navigation request;
parse the navigation request to determine a user identifier associated with a user of the client device;
based on the user identifier, access an activity database to identify a plurality of activity logs associated with the user, wherein the plurality of activity logs comprises usage characteristics corresponding to types of games the user plays, electronic games to which the user has access, a gaming device used to play the accessible electronic games, and timestamps for gameplay of the accessible electronic games;
based at least in part on the usage characteristics, generate a number of recommendations to buy one or more new electronic games, sell one or more of the accessible electronic games, or trade one or more of the accessible electronic games;
generate a multi-component user interface comprising the generated recommendations; and
send the multi-component user interface to the client device for presentation.

15. The non-transitory computer-readable medium of claim 14, wherein the navigation request comprises a plurality of data fields including the user identifier and an instruction to process a buy, sell, or trade transaction.

16. The non-transitory computer-readable medium of claim 14, where the executed instructions further cause the one or more servers to:
identify, based on the timestamps for game play, one or more inactive games, from the accessible electronic games, that the user has not accessed for a predetermined period of time; and
determine, from a game database, a market value for each of the one or more inactive games.

17. The non-transitory computer-readable medium of claim 16, wherein the executed instructions further cause the one or more servers to:
based on the types of games the user plays and the gaming device used to play the accessible electronic games, generate a recommendation to buy a specified electronic game, the specified electronic game being of a genre indicated by the types of games the user plays, and being compatible with the gaming device;
determine, from the game database, a market value for the specified electronic game; and
include the recommendation to buy the specified electronic game, and a purchase price corresponding to the market value for the specified electronic game, on the generated multi-component user interface.

18. An online gaming marketplace system comprising:
one or more processors; and
one or more memory resources storing instructions that, when executed by the one or more processors, cause the online gaming marketplace system to:
receive, from a client device, a navigation request;
parse the navigation request to determine a user identifier associated with a user of the client device;
based on the user identifier, access an activity database to identify a plurality of activity logs associated with the user, wherein the plurality of activity logs comprises usage characteristics corresponding to types of games the user plays, electronic games to which the user has access, a gaming device used to play the accessible electronic games, and timestamps for gameplay of the accessible electronic games;
based at least in part on the usage characteristics, generate a number of recommendations to buy one or more new electronic games, sell one or more of the accessible electronic games, or trade one or more of the accessible electronic games;
generate a multi-component user interface comprising the generated recommendations; and
send the multi-component user interface to the client device for presentation.

19. The online gaming marketplace system of claim 18, wherein the navigation request comprises a plurality of data fields including the user identifier and an instruction to process a buy, sell, or trade transaction.

20. The online gaming marketplace system of claim 19, wherein the plurality of data fields indicate current display characteristics of the client device, and wherein the executed instructions further cause the online gaming marketplace system to:
prior to sending the multi-component user interface to the client device for presentation, format the multi-component user interface to reflect the current display characteristics of the client device.
